(19) United States
(12) Patent Application Publication
(10) Pub. No.: US 2014/0110556 A1
(43) Pub. Date: Apr. 24, 2014

(54) PEDESTAL OF ELECTRONIC PRODUCTS

(71) Applicant: Ya-Li Mao, Dongguan (CN)

(72) Inventor: Ya-Li Mao, Dongguan (CN)

(21) Appl. No.: 13/656,726

(22) Filed: Oct. 21, 2012

(51) Int. Cl. F16M 11/00

(52) U.S. Cl. 248/558

(57) ABSTRACT

A pedestal of electronic product, which comprising: a colloid and a support; said support is fully covered in the colloid, and the support is made of flexible metal, such that the colloid could be deformed by the folding of the support, and the pedestal could be deformed accordingly to place electronic products; this utility model is characterized by that: traditional pedestals are fixed, but the shape of the pedestal of the present invention could be changed flexibly where necessary, or adjusted to the desired angle, or resumed from “S” shape to tabular shape in idle state, thus saving the space with better portability.

### FIELD OF THE INVENTION

The present invention relates generally to an electronic accessory, more particularly to a pedestal of electronic products.

### BACKGROUND OF INVENTION

Tablet PCs have been widely applied to various fields in the human society, for the convenience of using, usually be placed by the following ways:

1. Tablet PCs are placed on the desktop. Owing to the optical reflection, the users have to stretch forward their necks and lower their heads to watch clearly the contents displayed on tablet PC; if users use the tablet PCs continuously for few hours, the muscle of the users' shoulders and necks may become stiff, and their eyes are likely acerb and painful against their eyesight.

2. The users may sustain a tablet PC by arm to form a certain angle with the desktop to make them more easily to watch the screen of tablet PC; yet, they may find it inconvenient to operate the computer by a single or double hand, their fingers and wrists will also feel sore and exhausted.

3. Various pedestals are developed to support tablet PCs against the aforementioned problems, for instance, an “S-shaped” rubber pedestal can be used to lock the tablet PCs for easier operation; but, the angle of such prefabricated pedestal couldn't be adjusted, and its fixed shape also weakens its portability.

Thus, to overcome the aforementioned disadvantages of prior art, would become main issue of present invention, and the inventor has figured out a solution as following by decades of experience in this field.

### SUMMARY OF THE INVENTION

The present invention is intended to provide a novel pedestal of electronic products to overcome existing shortcomings of prior art.

The following technologies are introduced: the pedestal of electronic products comprises a colloid and support, of which said support is fully covered in the colloid; the support is made of flexible metal, such that the colloid can be deformed to place electronic products on the pedestal.

Said support is made of flexible metal sheet with a rectangular body.

Said support is made of several flexible metal bars.

Said support is made of a plurality of flexible metal wires.

Said support is designed with a loose-leaf structure, comprising: upper board, lower board and tail board, of which the upper board and lower board are connected by a locating pivot, while said tail board and lower board are also connected.

Said tail board is made of flexible metal board.

Said tail board is made of two pivoted arc boards.

Some bar-shaped grooves are formed on said upper surface of the colloid.

Some bar-shaped grooves are formed on said lower surface of the colloid.

Said colloid is made of either of the methyl silicone rubber or vinylsiloxane rubber; the metal support is made of either of the Zinc Aluminum alloy or Ferro Aluminum alloy.

The present invention is of tabular pattern in idle state; if it is intended for use, the support in the colloid is folded and deformed into a pedestal for electronic products. Meanwhile, the angle and curvature could be adjusted, where necessary, so as to obtain a desired angle for placement of the electronic products. Finally, the pedestal could be retracted for convenient storage.

### BRIEF DESCRIPTION OF THE DRAWINGS

FIG. 1 is a sectional view of preferred embodiment 1 of the present invention.

FIG. 2 is a top view of preferred embodiment 1 of the present invention;

FIG. 3 is a bottom view of preferred embodiment 1 of the present invention;

FIG. 4 is a sectional view of preferred embodiment 1 of the present invention.

FIG. 5 is a scheme of practicing preferred embodiment 1 of the present invention.

FIG. 6 is a top view of preferred embodiment 2 of the present invention;

FIG. 7 is a bottom view of preferred embodiment 2 of the present invention;

FIG. 8 is a sectional view of preferred embodiment 2 of the present invention.

FIG. 9 a scheme of practicing preferred embodiment 2 of the present invention.

FIG. 10 is a top view of preferred embodiment 3 of the present invention;

FIG. 11 is a bottom view of preferred embodiment 3 of the present invention.

FIG. 12 is a sectional view of preferred embodiment 3 of the present invention.

FIG. 13 a scheme of practicing preferred embodiment 3 of the present invention.

FIG. 14 is a lateral view of preferred embodiment 4 of the present invention.

FIG. 15 is a perspective view of the support in preferred embodiment 4 of the present invention.

FIG. 16 is a lateral view of preferred embodiment 5 of the present invention.

### DETAILED DESCRIPTION OF THE INVENTION

### Preferred Embodiment 1

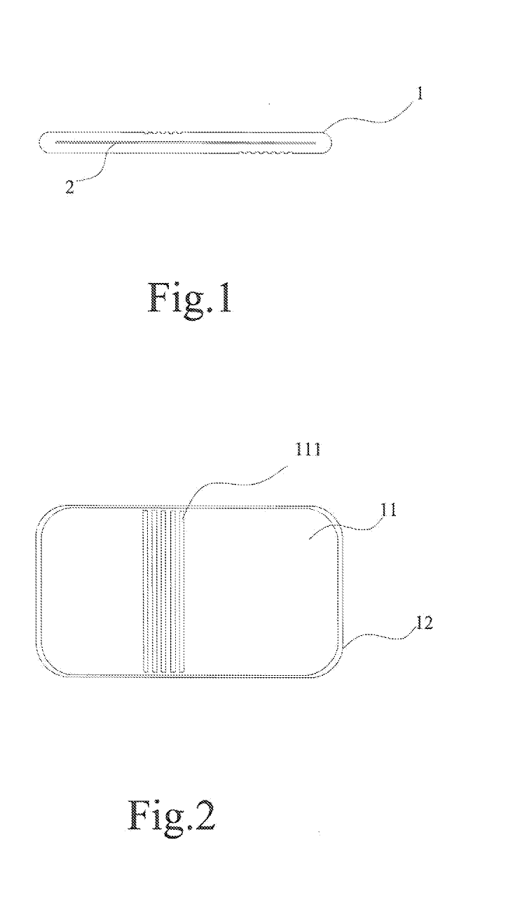

Referring to FIG. 1, the pedestal of electronic products comprises: a colloid 1 and a support 2; said support 2 is made of soft metal fully covered by the colloid 1. Some bar-shaped grooves 111, 121 are formed separately on said upper surface 11 and lower surface 12 of the colloid 1.

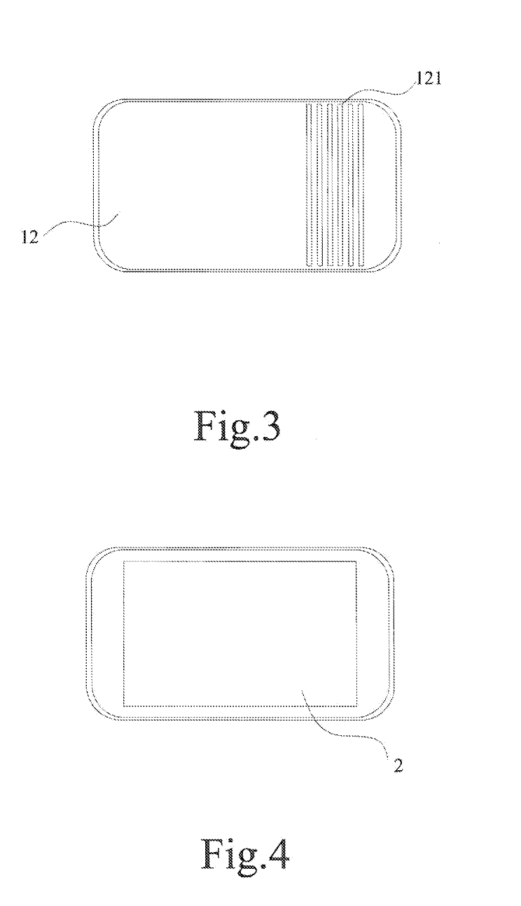

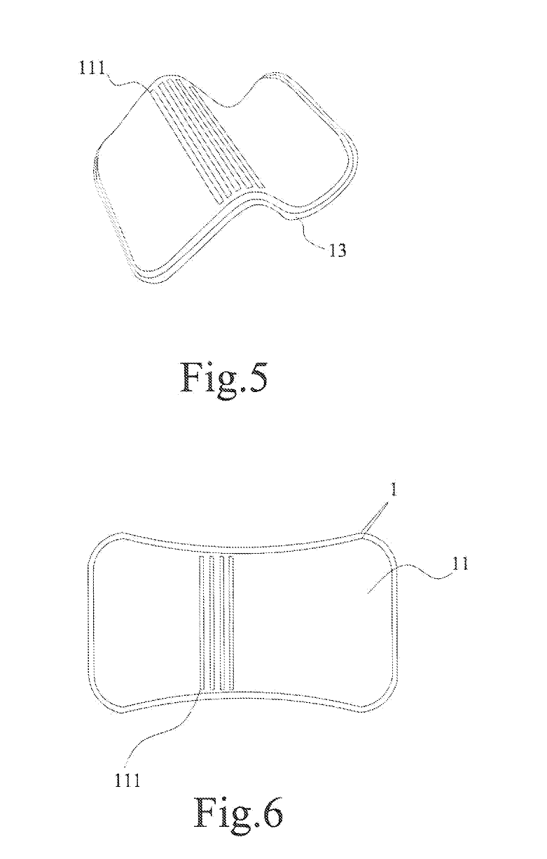

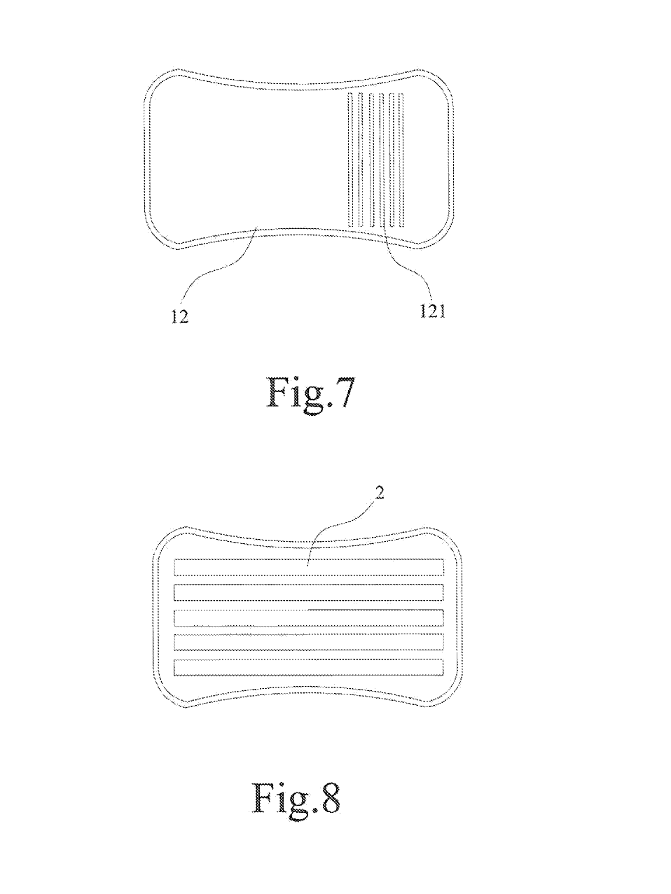

Said colloid 1 is made of methyl silicone rubber, and the soft metal is made of Zinc Aluminum alloy; said pedestal is fabricated in a way that the support 2 is covered by the colloid 1. Referring to FIG. 2, the colloid 1 is rectangular; referring to FIG. 4, the support 2 is also rectangular; the soft support is fully covered by the colloid 1 to form a pedestal. Four corners of the pedestal are arced to avoid bumping from manual operation. Referring to FIGS. 2, 3, the pedestal is tabular before folding; bar-shaped grooves 111, 121 are formed separately on the upper surface 11 and lower surface 12 of the pedestal. Due to the application of soft metal and colloid 1, deformation may occur when a force is applied to the pedestal, e.g.: folded downwards to a certain angle along the bar-shaped grooves 111, or upwards to a certain angle along the bar-shaped grooves 121, so as to form a shape as shown in FIG. 5; the downward folding end of the pedestal and the flexural portion 13 folded upwards along the bar-shaped grooves 121 are supported on the desktop, and the tablet PC is put on the pedestal; one end of the tablet PC is put on the flexural portion 13, and the other end sustained on the groove 121, than an oblique angle with the desktop is formed, which is adjustable by the need of users. The soft metal is covered by the colloid 1 to make sure the pedestal have sufficient strength to sustain the weight of the portable mobile devices, such that the tablet PC could be placed on the pedestal without damages on the shield due to the soft colloid 1. When this preferred embodiment is applied, the angle at two curves could be adjusted to 45°, 90° or others to meet different user demands; when finish using, the pedestal could be retracted and carried, thus, become more convenience of deploying and carrying.

### Preferred Embodiment 2

Referring to FIG. 1, the pedestal of electronic products comprises: a colloid 1 and a support 2; said support 2 is made of soft metal fully covered in the colloid 1. Some bar-shaped grooves 111, 121 are formed separately on said upper surface 11 and lower surface 12 of the colloid 1.

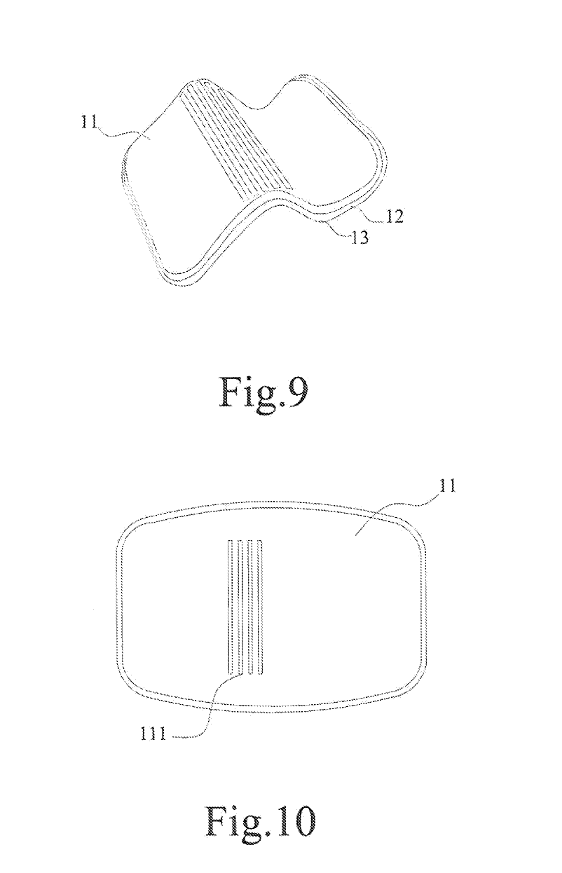

The colloid 1 is made of vinylsiloxane rubber, and the soft metal is made of Ferro Aluminum alloy; said pedestal is fabricated in a way that the support 2 is covered by the colloid 1. Referring to FIG. 6, the colloid 1 is rectangular with depressed sides and arced corners. Referring to FIG. 8, the support 2 is composed of rectangular metal bars, which are fully covered in the colloid 1 to form a pedestal with four arced corners. The pedestal is tabular before folding, as shown in FIG. 6, 7; bar-shaped grooves 111, 121 are formed separately on the upper surface 11 and lower surface 12 of the pedestal. Due to the application of soft metal and colloid, deformation may occur if a force is applied to the pedestal, e.g.: folded downwards to a certain angle along the bar-shaped grooves 111, or upwards to a certain angle along the bar-shaped grooves 121, so as to form a shape as shown in FIG. 9; the tablet PC is put on the pedestal to form an oblique angle with the desktop. When this preferred embodiment is used, the angle of the pedestal could be adjusted to meet different user demands; after the preferred embodiment is used, the pedestal could be retracted and carried, thus, more storage space is saved.

### Preferred Embodiment 3

Referring to FIG. 1, the pedestal of electronic products comprises: a colloid 1 and a support 2; said support 2 is made of soft metal fully covered in the colloid 1. Some bar-shaped grooves 111 and bar-shaped grooves 121 are formed separately on said upper surface 11 and lower surface 12 of the colloid 1.

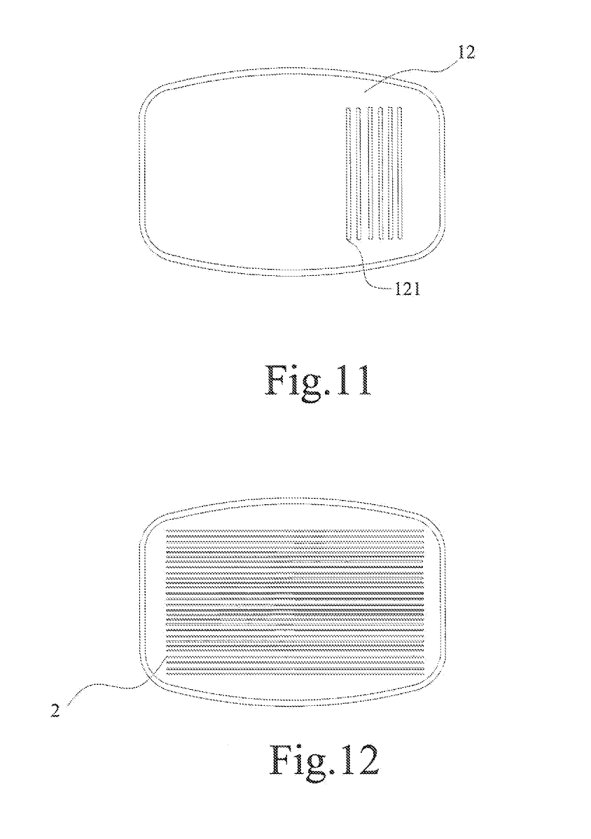

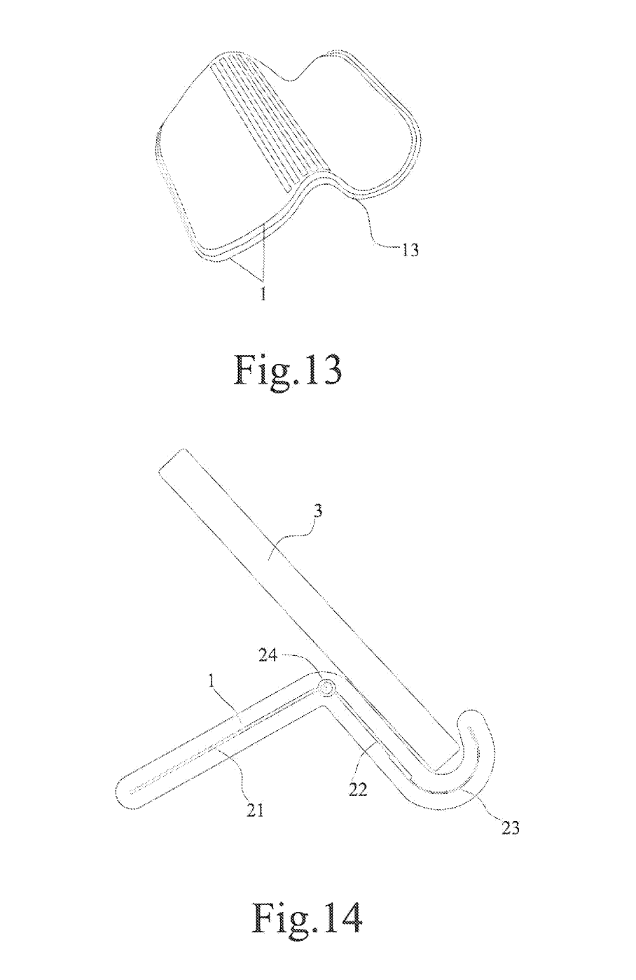

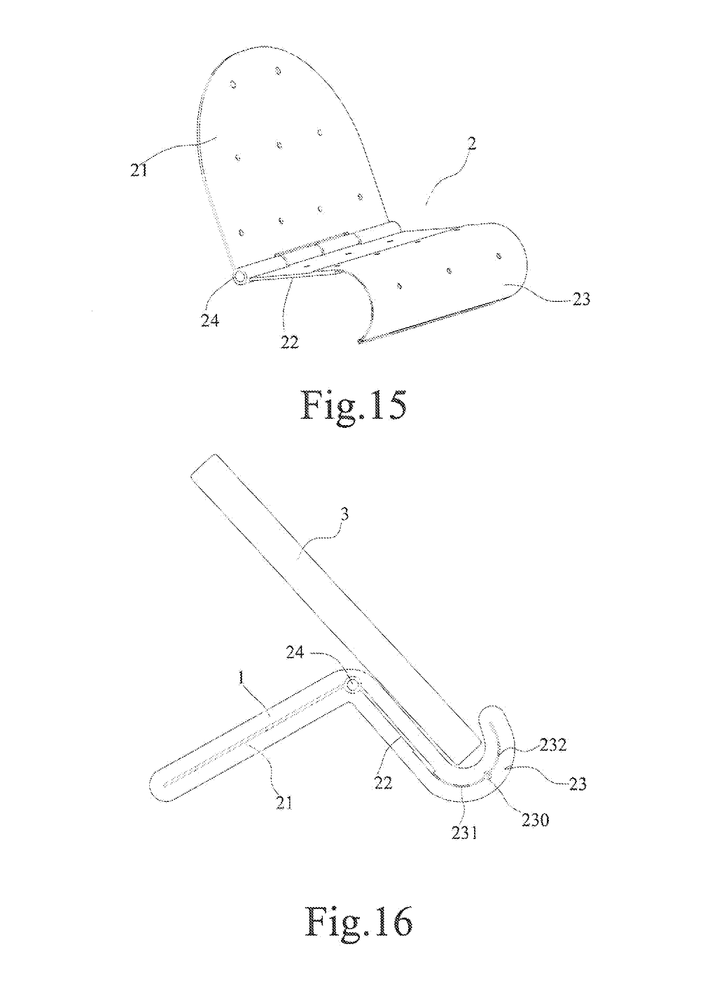

The colloid 1 is made of vinylsiloxane rubber, and the soft metal made of Zinc Aluminum alloy; said pedestal is fabricated in a way that the support 2 is covered by the colloid 1. Referring to FIG. 10, the colloid 1 is rectangular with protruded sides and arced corners. Referring to FIG. 12, the soft metal can also be metal wires, such that a plurality of metal wires are set uniformly in the soft colloid and fully covered therein to form the pedestal. Four corners of the pedestal are arced to avoid bumping arising from contact with square corners. The pedestal is tabular before folding, as shown in FIGS. 10, 11; bar-shaped grooves 111, 121 are formed separately on the upper and lower surfaces of the pedestal. Due to the application of soft metal and colloid, deformation may occur if a force is applied to the pedestal, e.g.: folded downwards to a certain angle along the bar-shaped grooves 111, or upwards to a certain angle along the bar-shaped grooves 121, so as to form a shape as shown in FIG. 13; the tablet PC is put on the pedestal to form an oblique angle with the desktop. When this preferred embodiment is used, the angle of the pedestal could be adjusted to meet different user demands; after the preferred embodiment is used, the pedestal could be retracted and carried, thus saving the storage space.

### Preferred Embodiment 4

Referring to FIG. 14, 15, the support 2 of this preferred embodiment is a loose-leaf structure unlike the aforementioned preferred embodiments.

Said support 2 comprises: upper board 21, lower board 22 and tail board 23, of which the upper board 21 and lower board 22 are connected by a locating pivot 24, while the tail board 23 and lower board 22 are also connected; the tail board 23 is made of flexible metal board. In detail, the upper board 21 and lower board 22 are fabricated by the cold-rolled sheet (of thickness about 1 mm), while the upper board 21 and lower board 22 are connected by a locating pivot 24. In this preferred embodiment, the locating pivot 24 can be stopped at any angle, and now is used in notebook computers and mobile phones, etc. Based upon the connecting and locating functions of the pivot 24, the upper and lower boards 21, 22 can be located at any desired folding angle.

In this preferred embodiment, the tail board 23 is made of galvanized board about 0.5 mm. So, the tail board 23 could be easily folded. Referring to FIG. 14, the upper and lower boards 21, 22 of this preferred embodiment are folded to “Λ” shape, while the tail board 23 is upturned to form a flexural groove. This preferred embodiment can be used as a pedestal for electronic products 3 such as mobile phones and tablet PCs.

Referring to FIG. 16, preferred embodiment 5 is basically of the same structure with the aforementioned ones; but the difference lies in that, the tail board 23 of this preferred embodiment is of a pin jointed structure. In this preferred embodiment, the tail board 23 comprises: two arc boards 231, 232 and a pivot 230 for connecting two arc boards 231, 232. With introduction of such structure, two arc boards are formed into a flexural groove for electronic products without need of folding the tail board 23.

The advantages of present invention are as following:

1. This could change the traditional operating mode that the tablet PC is placed directly on the desktop or sustained by a single hand; so, the users may not lower their heads and make their necks or shoulders stiff when watching the tablet PC, or feel acerb and painful when sustaining the tablet PC by a single hand.

2. The shape of the pedestal can be changed, allowing to adjust the angle where necessary, or the sustaining angle when using the tablet PC for a longer period of time, thereby altering the viewing angle and alleviating the fatigue of eyes.

3. Traditional pedestals are fixed, but the shape of the pedestal of the present invention could be changed flexibly, or resumed from “S” shape to tabular shape, thus saving the space with better portability.

Although the invention has been explained in relation to its preferred embodiment, it is to be understood that many other possible modifications and variations can be made without departing from the spirit and scope of the invention as hereinafter claimed.

1. A pedestal of electronic product, comprises:
A colloid;
A support;
Said colloid is rectangular, the soft support is fully covered by the colloid 1 to form a pedestal, and 4 corners are arced, bar-shaped grooves are formed separately on the upper surface and lower surface of the colloid;
Said support is fully covered by said colloid; and the support is made of flexible metal, such that the colloid could be deformed by the folding of the support, and the pedestal could be deformed accordingly to place electronic product.

2. The device defined in claim 1, wherein said colloid is made of either of the methyl silicone or vinylsiloxane rubber.

3. The device defined in claim 1, wherein said flexible metal is Aluminum alloy or Ferro Aluminum alloy.

4. The device defined in claim 1, wherein said support is a rectangular metal sheet.

5. The device defined in claim 1, wherein said support is composed of metal bars.

6. The device defined in claim 1, wherein said support is said support is composed of plurality of metal wires.

7. The device defined in claim 1, wherein said support is a loose-leaf structure, comprises:
An upper board;
A lower board; and
A tail board;
Said upper board and lower board are connected by a locating pivot,
while said tail board and lower board are also connected.

8. The device defined in claim 6, wherein said tail board is made of Aluminum alloy or Ferro Aluminum alloy.

9. The device defined in claim 6, wherein said tail board is assembled by two pivoted arc boards.
